(19) United States
(12) Patent Application Publication
(10) Pub. No.: US 2017/0023191 A1
(43) Pub. Date: Jan. 26, 2017

(54) PORTABLE HYBRID STREET LIGHT

(71) Applicant: Anthony K. MAGNOTTA, St. Paul, MN (US)

(72) Inventor: Anthony K. MAGNOTTA, St. Paul, MN (US)

(21) Appl. No.: 15/150,984

(22) Filed: May 10, 2016

Related U.S. Application Data
(60) Provisional application No. 62/160,167, filed on May 12, 2015.

(51) Int. Cl. F21L 14/04; H02J 3/38; F21V 21/22; B60P 3/18; H02J 7/35; F21L 4/08

(52) U.S. Cl. CPC F21L 14/04; H02J 7/355; F21L 4/08; F21V 21/22; B60P 3/18; H02J 3/383; H02J 3/386; F21W 2131/103

(57) ABSTRACT

The present invention relates to a portable or stationary light; and in particular, to a portable street light powered by renewable energy sources such as wind and solar energy.

### RELATED APPLICATIONS

The present application claims priority to and incorporates by reference U.S. Provisional Patent Application No. 62/160,167 filed May 12, 2015.

### BACKGROUND

Field of the Invention

The present invention relates to a portable light; and in particular, to a portable street light powered by renewable energy sources such as wind and solar energy.

BACKGROUND OF THE INVENTION

Mobile portable lighting systems are known in the art. These generally consist of systems that are mounted on trailers or other towable structures and that are powered in conventional manners. For example, the devices may interface directly into the electrical grid, or the devices may use a portable electrical generator powered by gas or diesel fuel.

While these systems can provide adequate lighting they suffer from a number of drawbacks. In particular, relying on the electrical grid is not always possible. In some instances lighting may be needed in an area with little or no access to electrical outlets, such as parks or other reasonably remote outdoor locations. In other instances, the available electrical outlets may not be able to provide sufficient power, or be configured to meet the power/wattage/current demands of the lighting devices. Or, in emergency situations power from the grid may not be available.

Additionally, use of the conventional power grid means reliance on carbon generating power means, which furthers various kinds of pollution as well as emitting greenhouse gasses associated with global warming.

Thus, there is a need exists for a portable lighting source that is not dependent on the electrical grid, and carbon based power sources.

### BRIEF DESCRIPTION OF THE FIGURES

FIG. 1 is a front side perspective view of the lighting device with the wind turbine in the upright position.

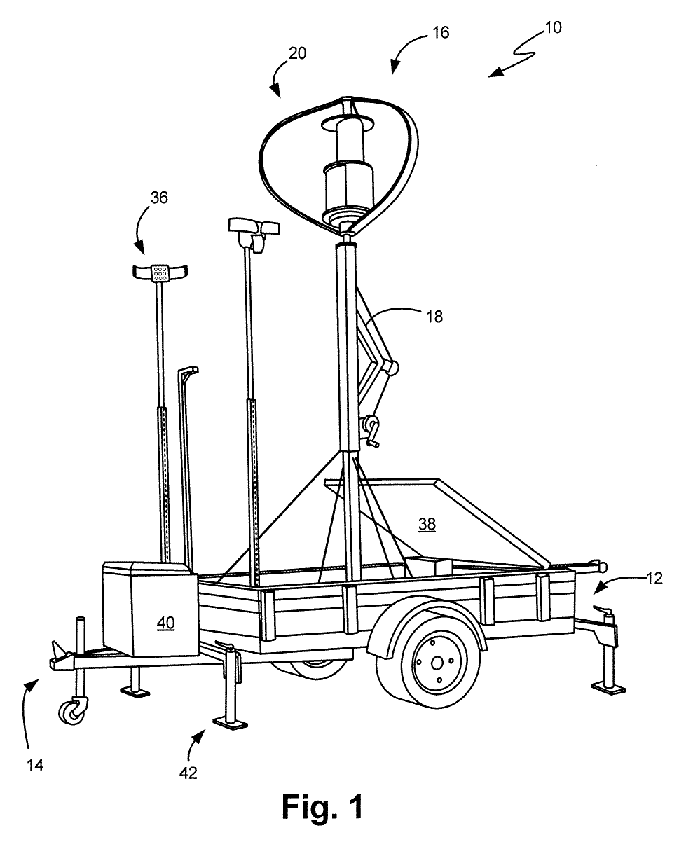

FIG. 2 is a back view of the device showing the solar panel array.

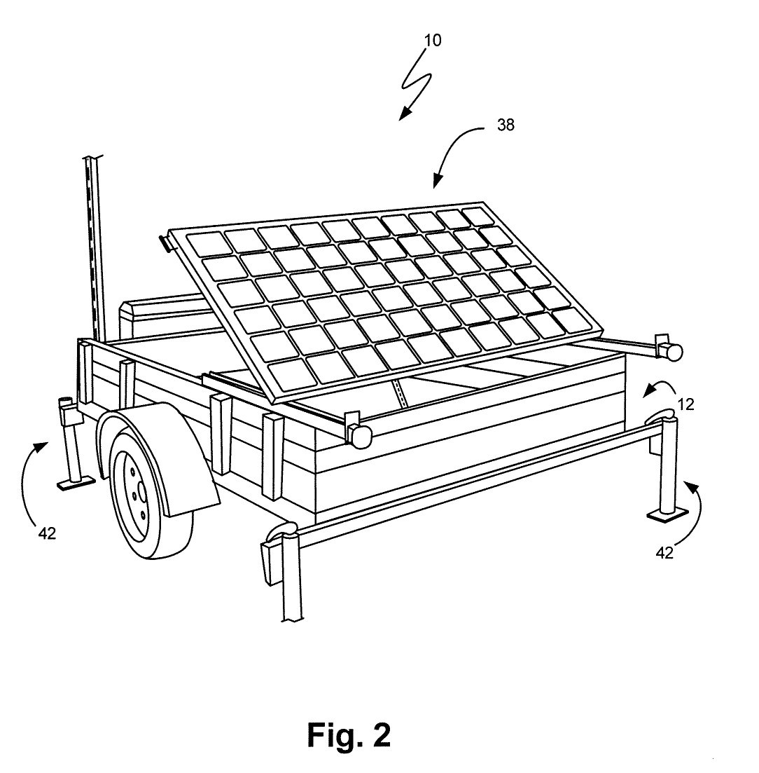

FIG. 3 is a view of a winch mechanism on the pole that supports the wind turbine.

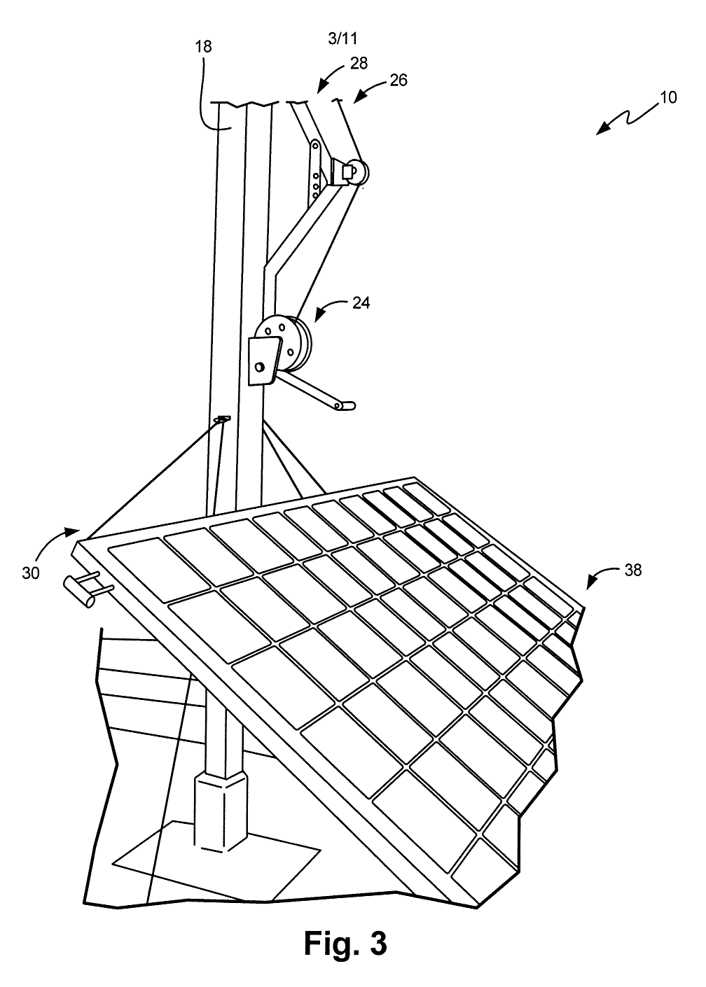

FIG. 4 is a view inside the electrical box showing batteries, inverter, and electronic controller.

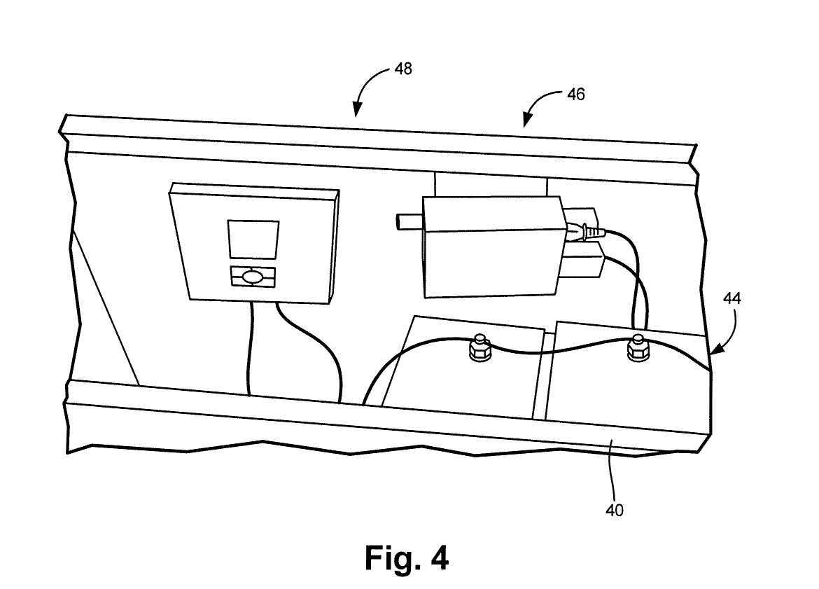

FIG. 5 is a front view of the device showing the lights, and wind turbine in the upright/operational position.

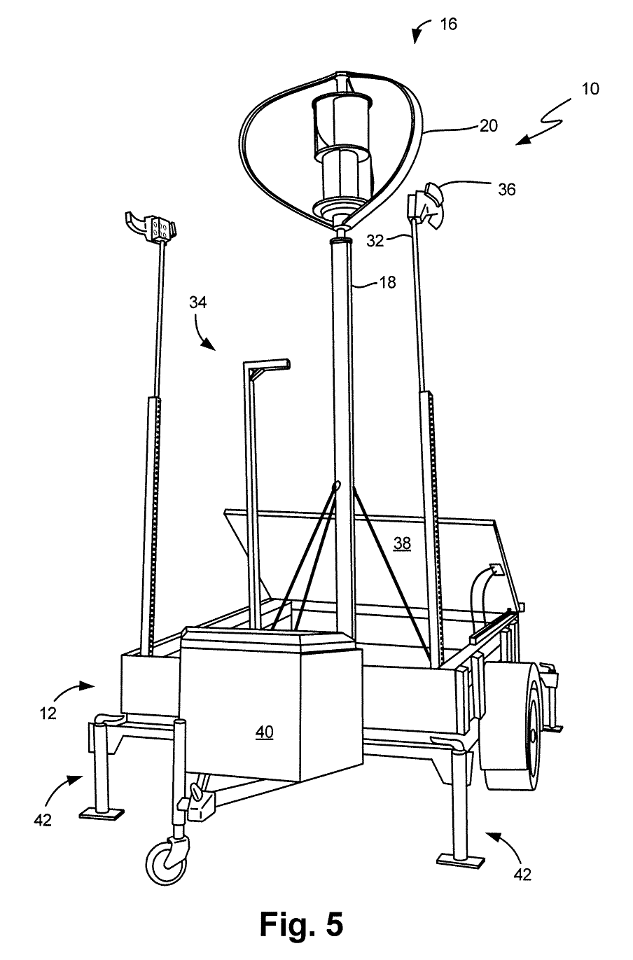

FIG. 6 is a side back view of the device showing the wind turbine in the upright position.

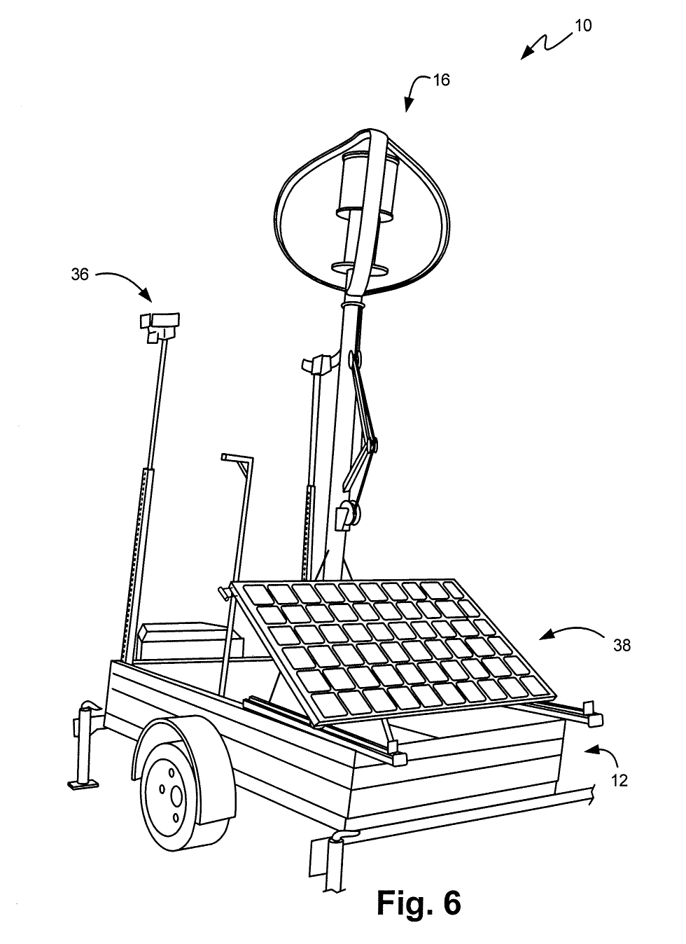

FIG. 7 is a side front view showing the lower portion of the pole that supports the wind turbine, and the back of the solar panel array.

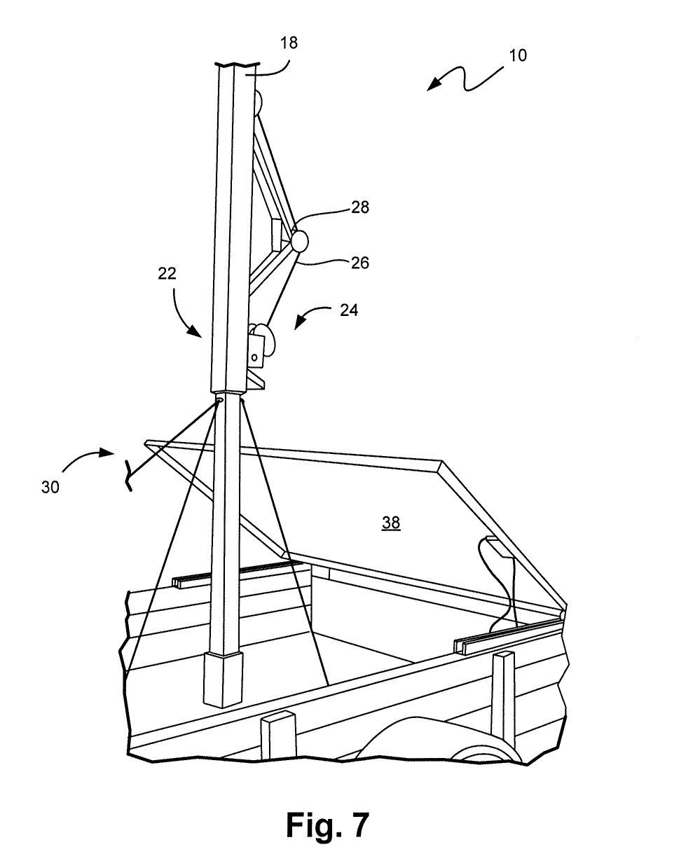

FIG. 8 is a close up view of the inside of the electrical box showing the batteries, inverter, and controller.

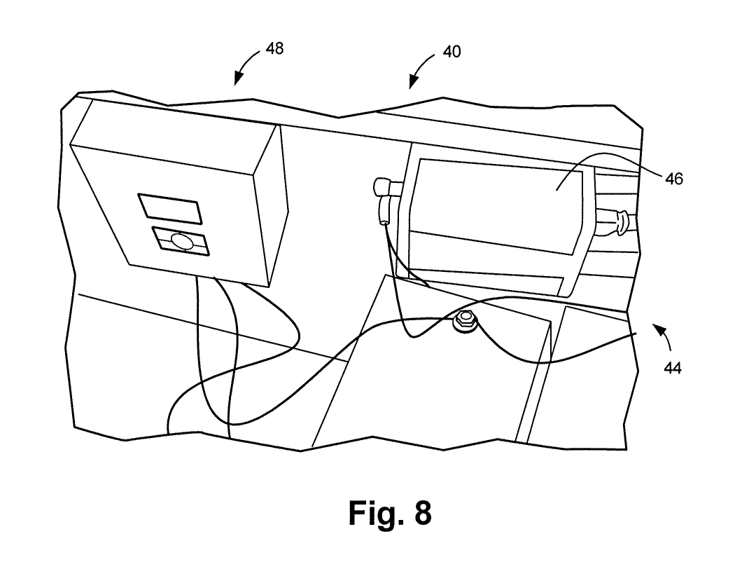

FIG. 9 is a side view of the device

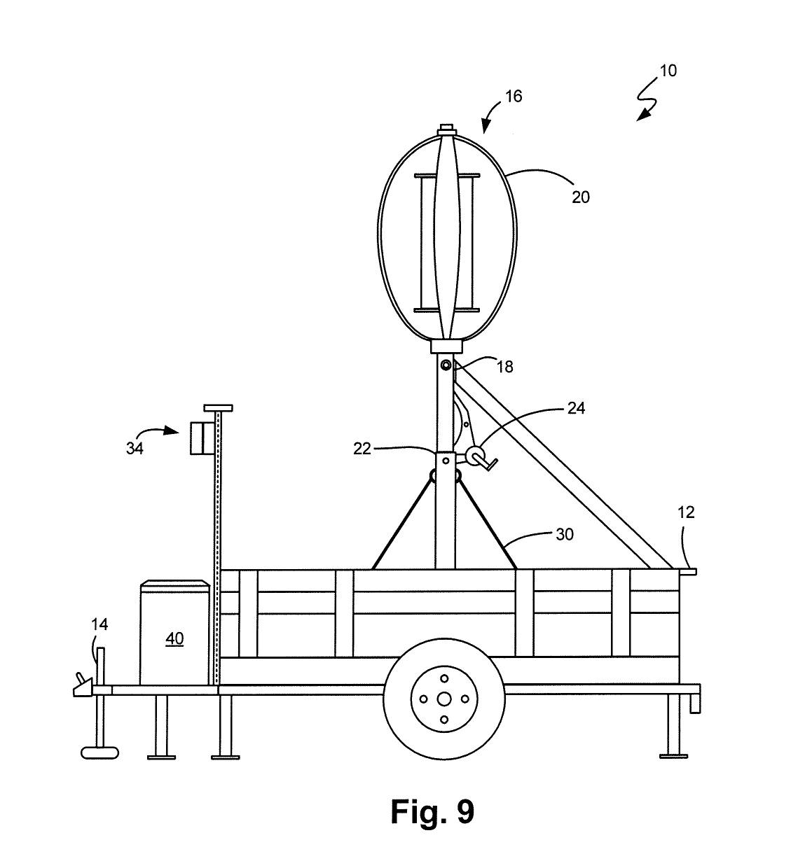

FIG. 10 is a front view of the device with the turbine in the reclining position, where the pole supporting the turbine is resting on a saddle of a support pole.

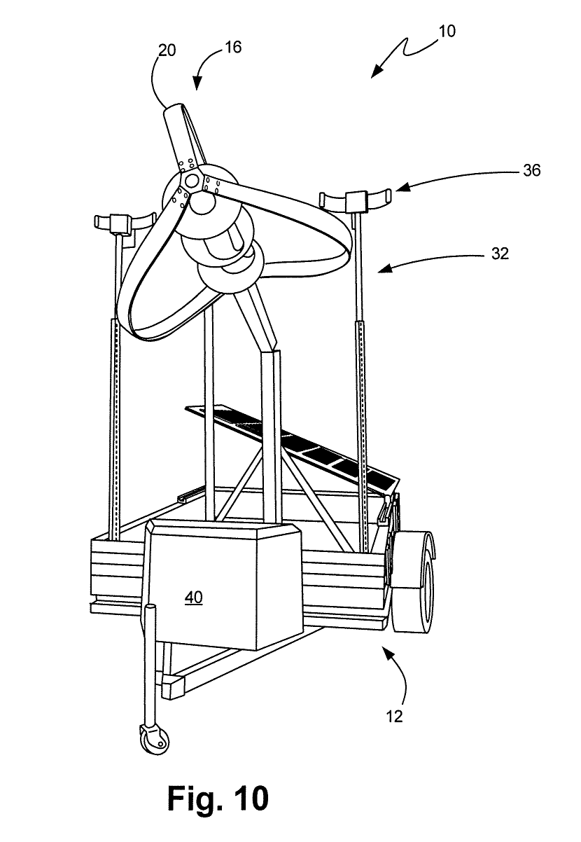

FIG. 11 is a side view of a stationary wind and solar power light.

### DETAILED DESCRIPTION OF THE INVENTION

In the Figures is shown a portable lighting device 10. The device 10 is housed in a trailer 12 having a hitch 14 adapted to be towed behind a vehicle (not shown).

The device 10 includes a vertical axis wind turbine 16 mounted atop of pole 18 anchored to the base of the trailer 12. The vertical axis turbine 16 is comprised of blades 20 which rotate in the wind in a circular path. The blades 20 do not have to be pointed into the wind. The blades turn a shaft or rotor, that is located inside the pole 18, which drives an electrical generator located that the base of the turbine 16 inside the trailer 12. The electricity can be stored in a battery for use as needed, or can be used to create direct electricity on demand.

The turbine 16 utilizes a main internally located rotor shaft that is generally arranged vertical to the direction of the wind. One advantage a vertical axis turbine is that the turbine does not need to be repositioned in case of a change in wind direction, which is an advantage on a site where the wind direction is highly variable. It is also has the advantage that it is inherently less steerable and can be more easily integrated into a structure such as the trailer. Also, the generator and gearbox can be placed near the ground, using a direct drive from the rotor assembly to the ground-based gearbox, improving accessibility for maintenance.

The pole 18 includes a hinge 22, which makes the pole 18 tiltable allowing the top portion of the pole 18 to be laid down toward the front of the trailer 12 during transport or storage. A winch 24 can be used to raise and lower the wind turbine 16 through cabling 26 that runs from the winch 14 to the top of the pole 18 and around a support frame 28. Guide wires 30 are arranged about the bottom of the pole 18 to provide stability to the wind turbine 16 when in the upright position. A pole 32 at the forward end of the trailer 12 provides a saddle 34 to receive the turbine pole 16 when it is in the reclined position.

The turbine 16 is one renewable power source for the lights 36, as well as a rear mounted solar panel array 38. In the preferred embodiment of the invention the wind turbine 16 is a 300-watt vertical axis turbine, and the solar panel 38 provided up to 280 watts. Different sizes and power rated devices can be used without departing from the scope of the invention.

The device 10 comprises two 110-volt LED pole mounted streetlights 36 that produce 2300 lumens of light in 360 degrees (between the two of them). The lights 36 can rotate to provide light in any direction. The lights 36 are mounted on poles 32 located at the forward end of the trailer 12. The light poles 32 are adjustable/telescoping to allow for positioning the lights 36 and to allow the lights 36 to be lowered during travel or storage and also to avoid contact with the wind turbine 16 when it is in the lowered position. The lights 36 can be raised to 9 feet. As with the other operational specifications, those of the lights 36 and poles 32 can and will vary without departing from the scope of the invention.

An electronics box 40 is located at the forward end of the trailer 12. The box 40 houses batteries 44 to store power from the wind turbine and solar panels, an inverter 46 for converting DC current to AC current. Also, a controller 48 for the wind turbine 16 and solar panels 38 is included. The batteries are rechargeable, and if necessary can accept power from the electrical grid.

The trailer includes four stabilizers 40 attached to the trailer 12 that can be lowered during operation to ensure the trailer 12 does not tip or move, especially when the wind turbine 16 is raises and in operation.

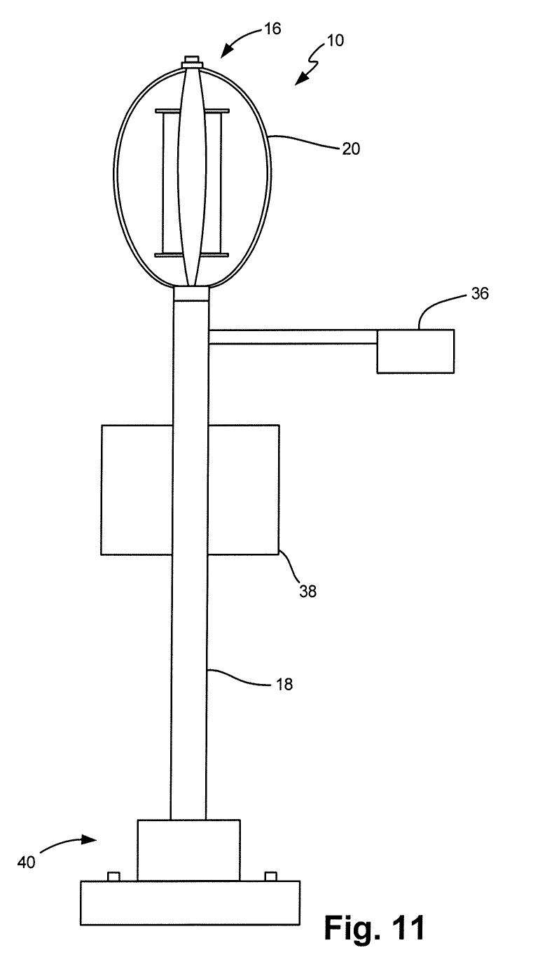

FIG. 11 shows an alternative embodiment of the present invention comprising a stationary device 10. The device 10 includes a turbine 16 mounted to a pole 18. A solar panel array 38 also mounted to the pole 18. The electronics 40 (battery, inverter, and controller) are housed in the base of the pole 18. Further, lights 36 are located on the pole 18.

The device 10 of the present invention substantially solves the problems of the prior art by providing a portable lighting source that does not rely on the power grid, and is powered by renewable energy sources thereby preventing emission of pollutants and/or greenhouse gases. The device can provide a high level of light from the power stored in the batteries, which comes primarily from solar and wind generated sources. The device can be used to meet all sorts of illumination needs, such as lighting constructions zones, signs, sporting events, concerts, and the like.

While the preferred embodiment of the invention has been described in reference to the Figures, the invention is not so limited.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. A portable lighting system, comprising:
a wheeled structure;
a wind turbine for generating electrical power located in the structure;
a set of solar panels for generating electrical power located in the structure;
a battery for storing the electrical power located in the structure;
a light powered by battery.

2. The invention of claim 1 where the structure is a trailer with a hitch to allow the trailer to be towed by a vehicle.

3. The invention of claim 1 further providing a second light.

4. The invention of claim 3 where the lights are mounted on telescoping and rotating poles to provide 360 degrees of light.

5. The invention of claim 1 where the turbine is a vertical axis turbine.

6. The invention of claim 1 where the turbine is mounted on a pole.

7. The invention of claim 6 where the pole is hinged and movable between an upright operational position and a reclining storage/transport position.

8. The invention of claim 7 where the pole is moved between positions by cables and a winch.

9. The invention of claim 2 where the trailer has a plurality of stabilizers attached thereto.

10. The invention of claim 9 where the trailer has four stabilizers.

11. The invention of claim 6 where the pole is supported by a plurality of guide wires.

12. The invention of claim 6 further comprising a pole with a saddle to support the pole when in the reclining position.

13. A lighting system, comprising:
a pole;
a wind turbine for generating electrical power located on the pole;
a set of solar panels for generating electrical power located on the pole;
a battery located at the base of the pole for storing the electrical power; and
a light located on the pole powered by battery.
